(19) United States
(12) Patent Application Publication
(10) Pub. No.: US 2009/0179182 A1
(43) Pub. Date: Jul. 16, 2009

(54) Fencing for residential and commercial use

(76) Inventors: Stephen M. Gladstone, Stamford, CT (US); Peter C. Aquilina, Seymour, CT (US)

Correspondence Address: Pamela L. Wingood;Ohlandt, Greeley, Ruggiero & Perle, L.L.P., 10th Floor, One Landmark Square, Stamford, CT, 06901-2682, US

(21) Appl. No.: 12/319,679

(22) Filed: Jan. 9, 2009

Related U.S. Application Data
(60) Provisional application No. 61/010,913, filed on Jan. 11, 2008.

(51) Int. Cl. E04H 17/04; E04H 17/02; A01G 25/00

(52) U.S. Cl. 256/32; 239/289

(57) ABSTRACT

The fence provides for a plurality of wires that are twisted together in pairs at a plurality of spaced elongated windings and spread to form openings. The spaced elongated windings lie in spaced parallel lines extending longitudinally in the mesh fence. The fence also includes a plurality of spaced apart parallel wires, wherein each of the plurality of spaced apart parallel wires extend through the spaced elongated windings lying in a line. Ones of the plurality of spaced apart parallel wires are conductive wires that are coupled to a connector to supply electricity to at least one electrical device.

This application claims the benefit of U.S. Provisional Patent Application Ser. No. 61/010,913, filed on Jan. 11, 2008, the contents of which are incorporated by reference herein.

### BACKGROUND OF THE INVENTION

1. Field of the Invention

This disclosure relates to fencing for residential and commercial use to support low and high voltage electrical devices.

2. Description of Related Art

Traditionally, fences that are used for wildlife abatement have been chain-link fences, welded/woven wire fences, or wooden fences. While these fences may be effective to varying degrees to prevent the encroachment of wildlife, they can also limit visibility and/or interfere with aesthetic vistas. There is a benefit to keeping unwanted wildlife outside of a yard, while still maintaining visibility beyond the yard. In addition to being a physical barrier for animals, fences must also be used for residential and commercial use to maintain compliance with safety codes and regulations. In both the residential and commercial setting, around pools, for example, fences are required equipment.

Additionally, fences are often located at regions where surveillance and/or lighting may be desired, such as airports or other site-sensitive locations, residential properties, along a traveled thoroughfare or near public parks. In these often remote locations, powering electrical equipment is often difficult and/or expensive.

Accordingly, there is a need for a fence that has the durability to abate or control wildlife, yet not restrict visibility, while providing a single platform from which electrical appliances may be used for additional uses such as surveillance, safety and/or lighting.

### SUMMARY OF THE INVENTION

The present disclosure provides for a fence having a hexagonal twist mesh configuration that is capable of supporting both low and high voltage electrical devices.

The present disclosure also provides for a fence having a hexagonal twist mesh configuration that has conductive wires extending therethrough to support electrical applications.

The present disclosure further provides for a fence having a hexagonal twist mesh configuration that has steel wires running therethrough in a horizontal orientation to provide stability and support.

The present disclosure yet further provides for a fence having a hexagonal twist mesh configuration that has conductive wires and steel wires therethrough.

The present disclosure still yet further provides for a fence having a hexagonal twist mesh configuration that after installation is almost invisible to the eye from several feet away and therefore does not impede viewing of the landscape.

The present disclosure yet further provides for a fence having a hexagonal twist mesh configuration in which the steel and conductive wires extend through the horizontal wound ends of each hexagonal member in an unwound configuration.

The present disclosure still yet further provides for a fence having a hexagonal twist mesh configuration that supports plumbing for plant irrigation.

The present disclosure yet still further provides for twist mesh hexagonal fencing for residential and commercial uses that incorporates reinforcement and conductive wires to provide a single platform for electrical appliances that may be used for wildlife abatement, site-sensitive security, swimming pool security and audio and video equipment.

The fence provides for a plurality of wires that are twisted together in pairs at a plurality of spaced elongated windings and spread to form openings. The spaced elongated windings lying in spaced parallel lines extending longitudinally in the mesh fence. The fence also includes a plurality of spaced apart parallel wires, wherein each of the plurality of spaced apart parallel wires extend through the spaced elongated windings lying in a line. Ones of the plurality of spaced apart parallel wires are conductive wires that are coupled to a connector to power at least one electrical device.

A mesh fence having a plurality of wires twisted together in pairs at a plurality of spaced elongated windings and being spread between each of the plurality of spaced elongated windings to form openings. The spaced elongated windings lying in spaced parallel lines extending longitudinally in the mesh fence. A plurality of spaced apart parallel elongate members, the extends through ones of the plurality of spaced elongated windings lying in a line. Ones of the plurality of spaced apart parallel elongate members being capable of transmitting electricity to at least one electrical device or being capable of providing irrigation.

### BRIEF DESCRIPTION OF THE DRAWINGS

Other and further benefits, advantages and features of the present invention will be understood by reference to the following specification in conjunction with the accompanying drawings, in which like elements of structure and:

FIG. 1 illustrates a portion of a hexagonal fence according to the present invention;

FIG. 2 illustrates a portion of a hexagonal fence according to a second configuration of the present invention; and

FIG. 3 illustrates a fence according to the present invention having wiring, tubing and connectors.

### DETAILED DESCRIPTION OF THE INVENTION

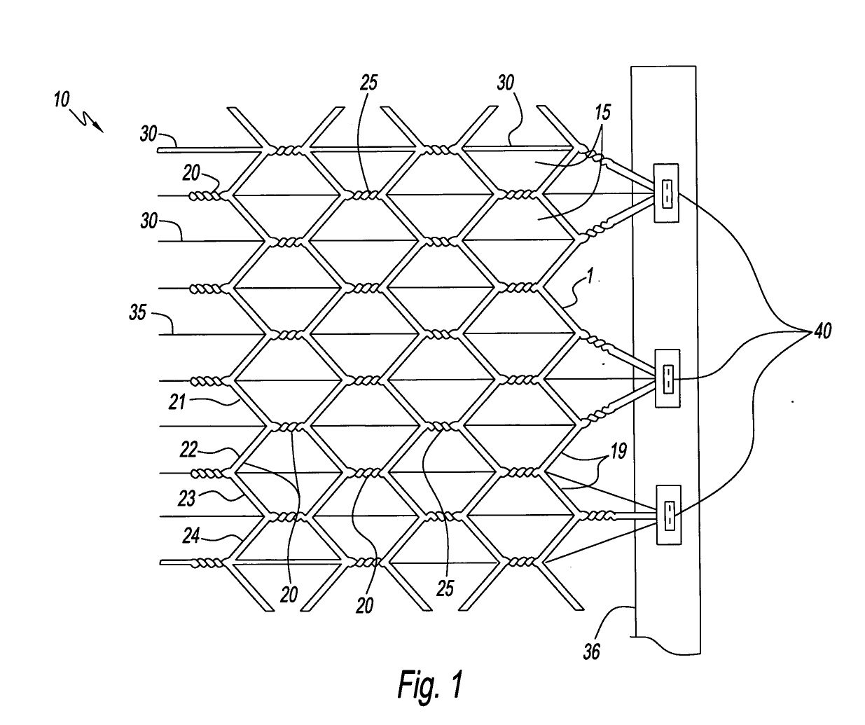

Referring to the drawings and in particular to FIG. 1, a portion of the fence according to the present invention is shown and generally referenced by reference numeral 10. Fence 10 contains a plurality of adjacent wires 19 that are twisted or wound together at elongated windings 20 and 25 and spread or spaced. Elongated windings 20 and 25 lie in a spaced parallel relationship and extend longitudinally along fence 10 to form a mesh. A plurality of adjacent wires 19 includes individual wires 21, 22, 23 and 24. For example, wires 22 and 23 are wound at elongated winding 20 and spread apart to be wound with adjacent wires 21 and 24, respectively. Wires 22 and 23 may again be wound at elongated winding 25 to form a hexagonal shape therebetween. Alternatively, wires 22 and 23 may each be wound with a different wire after being wound at elongated winding 20. Plurality of wires 19 are spread and wound with an adjacent wire to form a plurality of hexagonal shaped members 15 that interconnect to form mesh fence 10. This hexagonal configuration provides substantial flexibility to fence 10.

In FIG. 1, each hexagonal shaped member 15 has a wire extending therethrough. Wires are steel wires 30 or conductive wires 35 or other cabling/tubing discussed below. Significantly, wires 30,35 remain straight through each hexagonal member 15, and windings 20 and 25 during the winding process. When fence 10 is formed, steel wires 30 and conductive wires 35 remain straight and under tension, as plurality of wires 19 that form each hexagonal shaped member 15 are wound or twisted around wires 30 and 35, thereby minimizing stress on wires 30 and 35. Wires 30 and 35 are secured to supports 36 at edges of fence 10 to maintain tension in wires 30 and 35. While FIG. 1 shows a single vertical support 36, it should be understood that the opposite side of fence 10 is supported by a second support to which wires 19, 30 and 35 are connected.

Further, by being secured within the fence in a non-wound configuration, the non-wound conductive wires 35 and steel wires 30 are not subject to the stress of being wound with the other mesh wires. Were wires 30 and 35 wound as wires 19, the potential for electrical failure would damage the integrity of fences 50 or 60. The straight configuration of wires 30 and 35 provides necessary reliability to the fence 10.

Operatively associated with wires 35 are one or a plurality of connectors 40. Connectors 40 permit appliances or devices to be connected to conductive wires 35. Fence 10 is includes a coupling for connection to a locally supplied power source that would also supply power to a residence, for example. In this way, fence 10 serves as a platform to enable power to be provided to appliances that are connected thereto. When electrical appliances are connected to the one the plurality of connectors 40, fence 10 serves as a single platform to provide multiple power to a wide range of appliances that can be powered by low voltage conductive wires, for example. Connectors 40 associated with mesh fence 10 allow 12 volt or 24 volt connections for the lighting, cameras, speakers, controllers and sensors to provide remote access to power sources that had previously not been available with such fencing.

Referring to FIG. 1, conductive wires 35, preferably copper, have a parallel horizontal configuration. While copper is preferable, other metals that offer the same conductive ability could also be used for conductive wires 35. Conductive wires 35 are preferably pre-coated with an insulating material prior to incorporation into mesh fence 10. The steel wires 30 provide support and stability to hexagonal fence 50 and prevent elongation.

Further, the wires 30 can be of any desired gauge based upon the required strength of the fence. The hexagonal twist mesh configuration, steel wires 30 and conductive wires 35 are all coated with a thermoplastic polymer, such as, for example, black polyvinylchloride (PVC) to minimize visibility, enhance flexibility and increase both durability and longevity. Conductive wires 35 of the instant invention are preferably low voltage wires that can be used to power electrical appliances of many types.

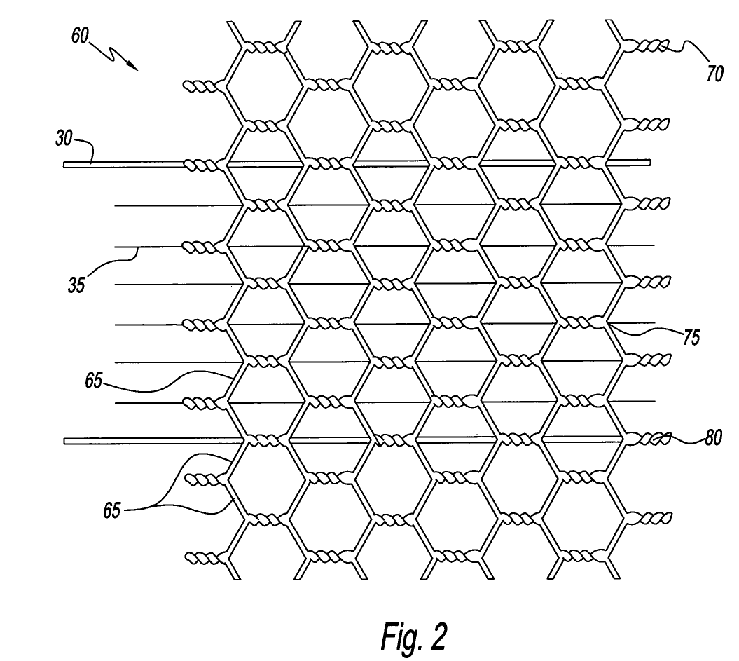

While the FIG. 1 shows eight conductive wires 35 paralleled by two heavier gauge steel wires 30, any configuration of wires 30, 35 can be used to achieve the user's needs. For example, in FIG. 2, according to an alternative configuration of the present invention, fence 60 has two steel wires 30 that parallel six conductive wires 35. Steel wires 30 are spaced more frequently across fence 60 to provide added stability and strength. Conductive wires 35 cannot be used for support; therefore, a fence with more steel wires 30 per a number of conductive wires 35 is stronger than a fence with fewer steel wires per the same number of conductive wires. Additionally, steel wires 30 relieve any stress that may be imparted to conductive wires 35 to ensure fence reliability and longevity.

Referring to FIG. 2, there are three types of elongated windings in fence 60. Elongated windings 70 include mesh wires 65 that form the hexagonal mesh of fence 60. Elongated windings 75 include mesh wires 65 that are wound around conductive wires 35. Elongated windings 80 include mesh wires 65 that are wound around steel wires 30. Mesh wires 65 would also be wound around tubing for irrigation tubing and any cables for lighting, camera and surveillance equipment. Similar, to the configuration of FIG. 1, wires 35 are powered by an appropriate power source have connectors to serve as a platform and power electrical outdoor appliances such as lighting, cameras and surveillance equipment, such as alarms, sensors or motion detectors.

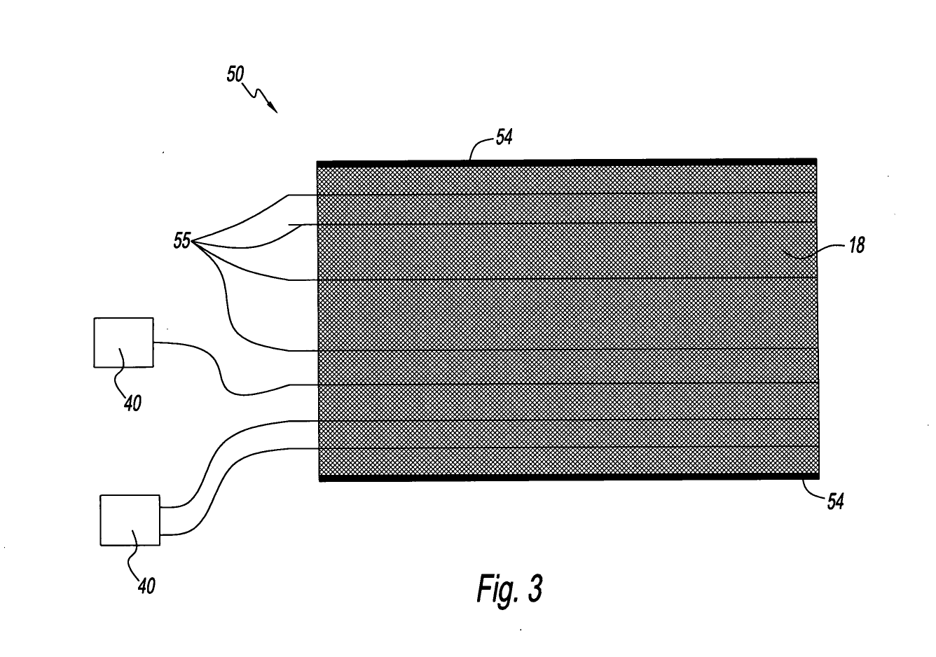

Referring to FIG. 3, a fence 50 using different parallel wires 55 and tubing 54, collectively called elongated members, are used to power audio and video equipment, such as speakers, cameras and video surveillance equipment and irrigation equipment. Fence 50 has a similar mesh configuration as fences 10 and 60 of FIGS. 1 and 2, respectively. Intercom communications, paging systems and intruder messaging systems can also be connected to fence 50 with the appropriate cabling. Wires 55 can be 12 volt wires, 24 volt wires, 110 volt wires, coaxial or cable wires. Thus the present invention has applicability for wires and/or cables that are capable providing power to many different devices. In additional to providing a platform for electrical applications/appliances, the hexagonal fence could also be a platform for tubing for irrigation using irrigation tubing 54. By using irrigation tubing 54, such as, for example, cross-linked polyethylene tubing of various diameters, drip irrigation and/or sprinkler systems, can be incorporated into mesh 18. The tubing 54 can be activated with timers and integrated into the upper or lower course of the mesh cabling. Tubing 54 has ports that are coupled to water sources to provide water for irrigation purposes.

Fence 50 merges electrical/irrigation capability using wires, cabling and or tubing, that are integrated into hexagonal mesh fencing. Operatively associated with wires 55 are one or a plurality of connectors 40. When electrical appliances are connected to the one the plurality of connectors 40, fence 10 serves as a single platform to provide multiple power to a wide range of appliances that can be powered by low voltage wires. Connectors 40 on the hexagonal fencing allow 12 volt or 24 volt connections for the lighting, cameras, speakers, controllers and sensors to provide remote access to power sources that had previously not been available with such fencing. Similar to fences 10 and 50 of FIGS. 1 and 2, respectively, a power source is also coupled to fence 50 to permit service as a platform for electronic devices.

Fence 50 of the present disclosure has residential and commercial application. Fence 50 can be used wherever there is a need to secure a boundary or to prevent entry into a property. In the residential setting, hexagonal twist mesh fences are desirable for wildlife abatement and help eliminate safety concerns at a boundary that may contain a pool or other similar structure or sensitive area.

Further, fence 50 can stretch and contort in ways that other fences are not able to because of the hexagonal mesh configuration. Hexagonal shaped members 15 make fence 50 inherently flexible and prone to elongation under tension. Accordingly, fence 50 can sustain a degree of damage, without causing an actual breach in the mesh, potentially compromising the protected area. Additionally, the flexible configuration of fence 50 permits a secure interface with the ground so that gaps between the fence and the ground can be eliminated. Even where there is moderate to severe undulation in the terrain, complete installation capability is achieved by the fence because of its flexibility.

Additionally, the black PVC coating makes the fence ideal for a residential setting such as near a pool because the fence does not diminish the view or block out views of trees and shrubbery. The camouflaged fence allows the feeling of openness but does not allow access. The fence becomes essentially invisible to the eye at a close distance. Even through a user may want to secure a perimeter, visibility beyond the perimeter is still desirable and possible.

Further, conductive wires 35 and 55 that are integral to the hexagonal mesh fence 50 have particular applicability to the residential environment. The ability to provide video, lighting, surveillance, or motion sensor capability at remote locations from the residence is very valuable and convenient. In particular, around pools the fence of the present disclosure offers the appropriate strength and security by providing a single platform for motion sensors for monitoring the deck and water. Such sensors are required by many state laws. In the commercial setting, the same benefits are also provided by the embedded conductive wires.

The present disclosure having been thus described with particular reference to the preferred forms thereof, it will be obvious that various changes and modifications may be made therein without departing from the spirit and scope of the present invention as defined in the disclosure.

We claim:

1. A fence comprising:
a plurality of wires twisted together in pairs at a plurality of spaced elongated windings, said plurality of wires being spread between each of said plurality of spaced elongated windings to form openings;
said plurality of spaced elongated windings lying in spaced parallel lines extending longitudinally to form the fence; and
a plurality of spaced apart parallel wires, wherein each of said plurality of parallel wires extend through ones of said plurality of spaced elongated windings lying in a line,
wherein at least one of said plurality of spaced apart parallel wires is a conductive wire that is connected to at least one electrical device to supply power to said at least one electrical device.

2. The fence of according to claim 1, wherein said openings are hexagonal shaped openings.

3. The fence according to claim 1, wherein each of said plurality of spaced apart wires extend unwound through said plurality of spaced elongated windings.

4. The fence according to claim 1, wherein at least one of said plurality of spaced apart parallel wires is a steel wire.

5. The fence according to claim 1, wherein said conductive wires are copper wires.

6. The fence according to claim 1, wherein each of said plurality of twisted wires are coated with a thermoplastic polymer.

7. The fence according to claim 1, wherein said at lease one conductive wire is coated with an insulating material prior to incorporation in the fence.

8. The fence according to claim 1, further comprising a coupling for connection to a power source and a plurality of connectors for connection to a plurality of electrical devices.

9. The fence according to claim 8, wherein said electrical devices are selected from the group consisting of sensors, cameras, speakers, and video surveillance equipment.

10. The fence according to claim 1, wherein said at least one conductive wire further comprises plurality of conductive wires further comprising coaxial cable.

11. The fence according to claim 1, further comprising at least one irrigation tube, wherein said irrigation tube extends through said plurality of spaced elongated windings.

12. A mesh fence comprising:
a plurality of wires twisted together in pairs at a plurality of spaced elongated windings and being spread between each of said plurality of spaced elongated windings to form openings;
said plurality of spaced elongated windings lying in spaced parallel lines extending longitudinally in the mesh fence; and
a plurality of spaced apart parallel elongate members, wherein each of said plurality of spaced apart parallel elongate members extends through ones of said plurality of spaced elongated windings lying in a line,
wherein ones of said plurality of spaced apart parallel elongate members are capable of transmitting electricity to at least one electrical device or providing irrigation.

13. The fence of according to claim 12, wherein said openings are hexagonal shaped openings.

14. The fence according to claim 12, wherein each of said plurality of spaced apart elongate members extend unwound through ones of said spaced elongated windings lying in a line.

15. The fence according to claim 12, wherein ones of said plurality of spaced apart parallel elongate members are steel wires.

16. The fence according to claim 12, wherein ones of said spaced apart elongate members are said conductive wires.

17. The fence according to claim 16, wherein said conductive wires are copper wires.

18. The fence according to claim 16, wherein said conductive wires are coated with an insulating material prior to incorporation in the mesh fence.

19. The fence according to claim 16, wherein said conductive wires further comprise coaxial cables.

20. The fence according to claim 12, wherein said plurality of twisted wires are coated with a thermoplastic polymer.

21. The fence according to claim 12, further comprising a coupling for connection to a power source and a plurality of connectors for connection to a plurality of electrical devices.

22. The fence according to claim 12, wherein said at least one electrical device is a plurality of electrical devices selected from the group consisting of sensors, cameras, speakers, and video surveillance equipment.

23. The fence according to claim 12, wherein at least one of said plurality of spaced apart parallel elongate members is an irrigation tube being coupled to a water source for irrigation.
